(19) United States
(12) Patent Application Publication
(10) Pub. No.: US 2002/0056353 A1
(43) Pub. Date: May 16, 2002

(54) Swivel vise

(76) Inventor: Vincent A. Zito, Manchester, CT (US)

Correspondence Address: McCormick, Paulding & Huber, City Place II, 185 Asylum Street, Hartford, CT, 06103-3402, US

(21) Appl. No.: 10/036,191

(22) Filed: Dec. 28, 2001

Related U.S. Application Data
(63) Continuation-in-part of application No. 09/586,149, filed on Jun. 2, 2000, now abandoned.

(51) Int. Cl. B26D 7/02

(52) U.S. Cl. 83/466; 83/468.3

(57) ABSTRACT

A swivel vise for use on a machine tool having a generally horizontal upwardly exposed surface with at least one mounting slot comprises substantially identical vise sub-assemblies of opposite hand. Each assembly has a meter gauge and is angularly movable on the table surface. Angular positioning of the jaws and a workpiece relative to a saw blade or the like is readily accomplished by first establishing a desired angle and then simply tightening a binder screw, and thereafter fixing the vise sub-assemblies relative to the mounting slot with a clamping device. Cutting compound angles and other cutting operations are thus readily accommodated.

### RELATED APPLICATIONS

This application is a Continuation-in-Part of U.S. application Ser. No. 09/586,149 filed on Jun. 2, 2000.

### FIELD OF THE INVENTION

This invention relates in general to work holders and, more particularly, to an improved machine tool vise for holding a workpiece in a stationary position on a work table while a tool moves relative to the table and in machining engagement with the workpiece.

### BACKGROUND OF THE INVENTION

The vise of the present invention is particularly adapted for use with a machine tool of the type having a table which includes a work surface, one or more elongated rectilinear mounting slots which open upwardly through the work surface, and a tool supported on a movable carriage above the table for movement relative to the table as, for example, a cutoff saw of the type having a power operated vertically extending band saw blade. A typical band saw of this type has an upright column which carries band saw wheels and a continuous saw blade loop which is mounted on a traveling carriage supported beneath the table surface. The saw blade can be moved in precise parallel alignment with the rectilinear tool holder mounting slots. Conventionally, the column can be tilted in one or an opposite direction and locked in position relative to the table, for example, at angles up to 45° leftwardly or rightwardly of its vertical position. However, the column and the blade can be moved only along a precise linear path relative to a workpiece supported on the table.

A vise assembly employed with a band saw machine of the type mentioned usually employs opposing parallel jaws for mounting a workpiece in a predetermined fixed position relative to a desired cutting plane. When a compound angle cut is required it is usually necessary to remove the vise from the machine, secure the workpiece to be cut to the table with other hold down devices engaged in the mounting slots or perhaps employ a jig or fixture to hold the workpiece in a desired position. The provision of such special holding devices is of course inefficient and time consuming and results in an increase in down time and labor costs.

It is a general object of the present invention to provide an improved vise assembly in the form of a swivel vise which may be adjusted angularly relative to a fixed cutting plane of a band saw or other machine tool, the cutting of compound angles, large angle plates, odd shaped pieces and other workpieces thus being greatly facilitated.

### SUMMARY OF THE INVENTION

In fulfillment of the aforementioned object and in accordance with the present invention, a swivel vise is provided for use on a machine tool table having a generally horizontally extending upwardly exposed surface with at least one elongated rectilinear mounting slot opening upwardly through the table surface. The vise comprises a pair of substantially identical vise sub-assemblies of opposite hand each having a base including a meter gauge and each adapted to rest on and to be both linearly and angularly movable on the table surface. A vise plate or jaw is affixed to each base and extends upwardly therefrom to define a substantially vertical workpiece clamping surface. The cooperating clamping surfaces are in opposing relationship when the vise sub-assemblies are mounted on the machine table in operative relationship. Each vise sub-assembly also has a first manually operable locking device for cooperation with the mounting slot side walls in fixing its corresponding vise sub-assembly in selected angular positions through a range of approximately 90° relative to the table and the mounting slot. The meter gauges serve to facilitate the desired angular settings of the two vise sub-assemblies relative to the table and to each other. A second manually operable locking device fixes its vise sub-assembly in selected positions linearly along the mounting slot.

More particularly, each of the first manually operable locking devices is operatively associated with its meter gauge to facilitate visual selection of a desired angular position of its vise sub-assembly. Depending front and rear guides associated with each meter gauge extend downwardly and enter an associated vise mounting slot. The guides are laterally restrained by the vise mounting slot walls but are slidable therealong. The front guide is also rotatable relative to the vise sub-assembly so as to accommodate angular movement thereof. The rear guide is slidably mounted relative to its meter gauge and adapted to be fixed relative thereto whereby to establish selected angular positions of its vise sub-assembly.

More specifically, each meter gauge takes the form of an arcuate member which in turn defines an arcuate slot for receiving an upper portion of its associated rear guide, a lower portion thereof entering the mounting slot. A binder bolt secures the guide in selected positions along its arcuate member.

Each of the second manually operable locking devices takes the form of a small frame which carries a threaded clamping member adapted for manual manipulation. A depending locking portion of the frame is adapted to enter a mounting slot and cooperate with the top walls thereof in locking the vise sub-assembly at selected positions along the slot. A reaction element provided for cooperation with the threaded clamping member is fixed relative to the sub-assembly base and jaw and serves to secure the depending locking member in the slot. The reaction element takes a generally frusto-conical configuration and the threaded clamping member is mounted angularly on the frame so as to engage the conical surface of the element perpendicularly. Thus, the frame and depending portion of the clamping device are drawn vertically upwardly to simultaneously lock its said depending portion in the mounting slot and to urge the associated vise jaw to move both vertically downwardly and horizontally to firmly engage the base of the sub-assembly with the table and to urge the saw into firm engagement with an adjacent workpiece.

Finally, it is to be noted that each of the jaw plates is mounted on its associated base for limited horizontal adjustment relative thereto. Thus, when an angular adjustment of the jaws results in inadequate or excessive spacing between the jaws and the saw or other machine tool, the jaws may be adjusted horizontally to a more desirable position relative thereto.

### BRIEF DESCRIPTION OF THE DRAWINGS

FIG. 1 is a schematic perspective view of a band saw machine provided with a conventional vise assembly.

FIG. 2 is a schematic plan view of the improved swivel vise assembly of the present invention arranged in perpendicular relationship with a band saw.

FIG. 3 is a similar schematic plan view with the swivel vise arranged in a selected angular relationship with the band saw.

FIG. 4 is a rear view of a single vise assembly.

FIG. 5 is a partially sectional side view of a vise sub-assembly, including a clamping assembly associated therewith.

FIG. 6 is a fragmentary transverse sectional view of a T-slot showing the connection between the slot and clamping device.

### DESCRIPTION OF THE PREFERRED EMBODIMENT

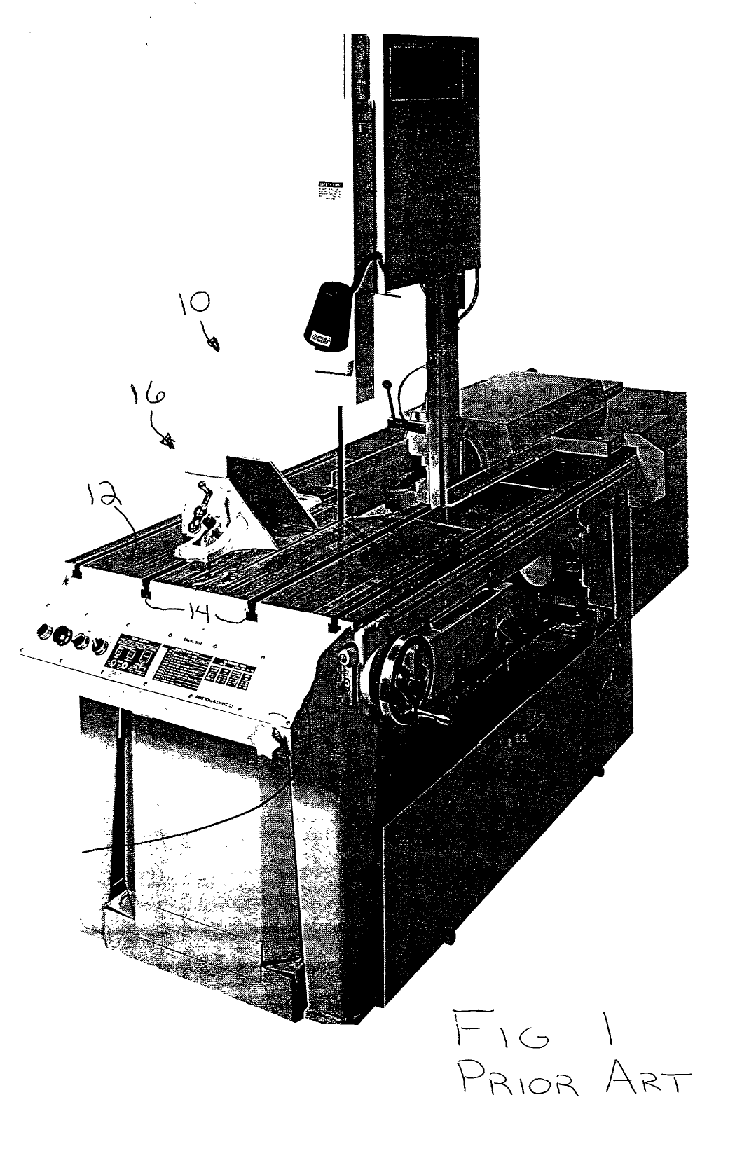

Referring initially to FIG. 1, it will be observed that a vertical band saw machine indicated generally at 10 is provided with a horizontally extending upwardly exposed table surface 12. A number of elongated rectilinear mounting slots for vise assemblies or other work holders are provided, “Tee” slots being shown, and a conventional vise assembly is illustrated generally at 16. Vise assemblies of the type shown at 16 are generally satisfactory but subject to the aforementioned limitations.

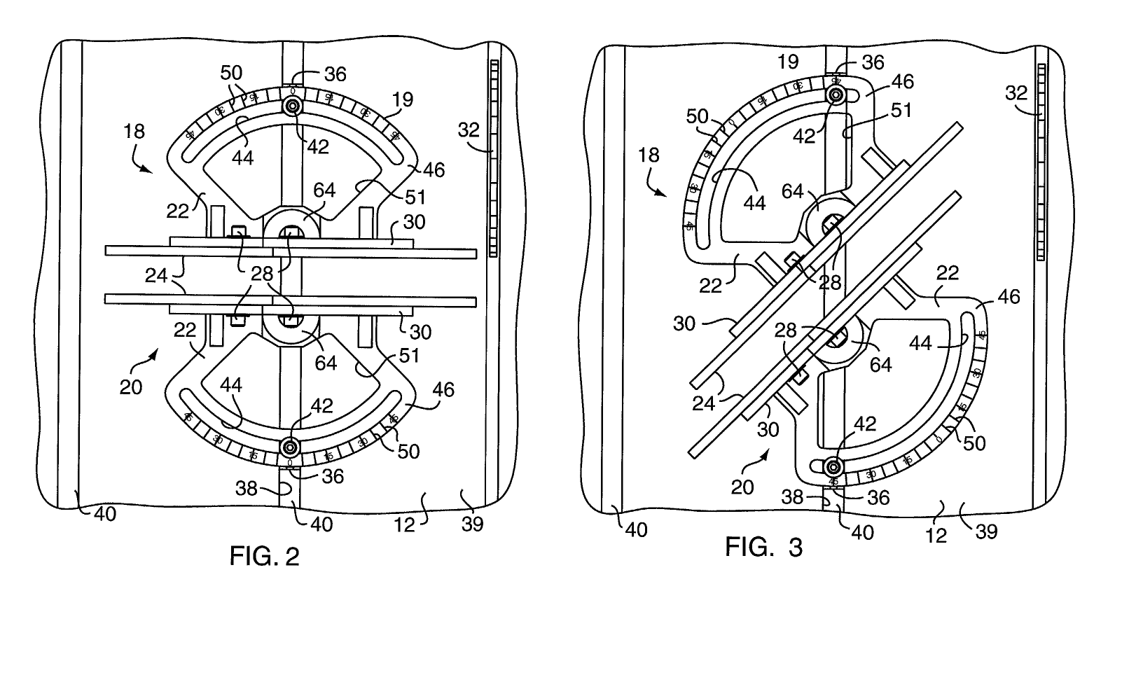

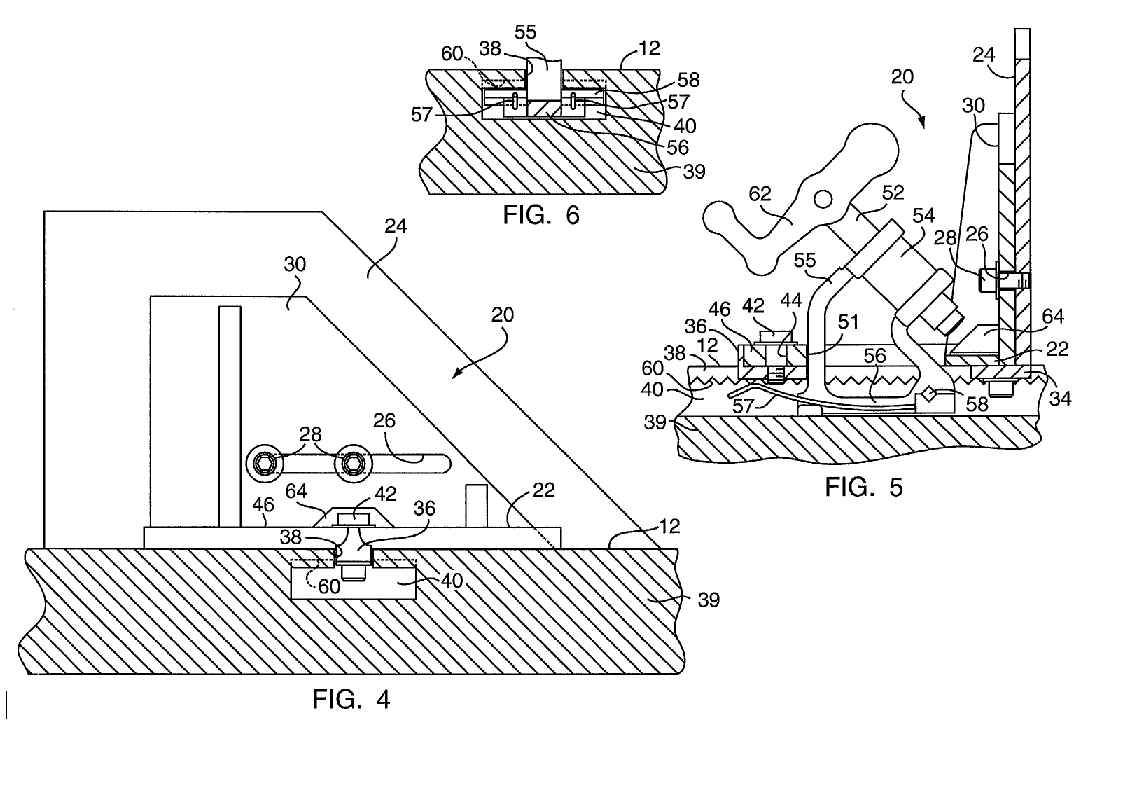

In FIG. 2 an improved swivel vise of the present invention is illustrated with a pair of vise sub-assemblies 18 and 20 of opposite hand. Each vise sub-assembly has a base 22 supporting a vise jaw 24. The jaws 24, 24 in FIG. 2 take the configuration of generally flat, plate-like members with vertically exposed faces in opposing relationship. At one end portion of each of the jaws 24, 24, an angular configuration is preferably provided as with the edge of the jaws inclined upwardly and leftwardly in FIG. 4. The jaws may of course also be arranged in reverse orientation.

As is also best illustrated in FIG. 4, a horizontal adjustment slot is provided at 26, 26 in each jaw with a pair of binder screws 28, 28 in the slots securing the jaw plates 24, 24 to upstanding portions 30, 30 of the bases of the vise sub-assemblies. Thus, the jaws may be readily adjusted horizontally as required to position a workpiece in a desired location relative to an associated cutting tool such as a band saw 32.

In FIG. 3 the vise sub-assemblies 18, 20 are shown adjusted through approximately 45° to a desired angular relationship with the saw blade 32. The adjustment is accommodated by slidable front and rear guides best illustrated respectively at 36 and 34 in FIGS. 4 and 5. As best shown in FIGS. 3 and 4, rear guide 36 extends downwardly from and beneath the meter gauge 19 into the neck 38 of a Tee slot 40 formed in the surface 12 of the work table 39 of a machine tool. The front guide 34 similarly extends downwardly, slidably enters and is restrained laterally by the neck 38 of the Tee slot but is rotatable relative to the base 22 of its vise assembly. Thus, binder bolt 42 operatively associated with rear guide 36, may be loosened to allow the entire base 22 including the meter gauge 19 to be rotated about the guide 34 to a desired angular position as in the FIG. 3 forty-five degree (45°) position. The binder bolts 42, 42 are disposed in identical arcuate meter gauge slots 44, 44 formed in similar arcuate members 46, 46 forming parts of the bases 22, 22 of the vise sub-assemblies. Thus, degree markings 50, 50 adjacent and along the arcuate slots 44, 44 facilitate the selection of desired angular positions for vise sub-assemblies and the binder bolts 42, 42 may thereafter be tightened to maintain the vise sub-assemblies in desired positions of adjustment. The guides 36, 36 and the binder bolts 42, 42 form first manually operable locking devices employed in establishing desired angular attitudes of the vise sub-assemblies.

A single second manually operable locking device is illustrated in FIG. 5 on the table surface 12 loosely disposed within an opening 51 defined by the miter gauge 19. The device includes a threaded clamping member 52 entered for rotation in a complimentary threaded portion 54 of a small frame 55 which also has a depending portion 56. The frame portion 56 carries a small transversely extending locking bar 58 within the aforementioned Tee slot 40 and which has opposite end portions engageable with spaced inverted rack gear sections 60, 60 on the top wall of the slot. In FIGS. 5 and 6 the locking bar 58 and the rack gear sections 60, 60 are disengaged by gravity and the action of leaf spring 57. That is, leaf spring 57 tends to urge the depending frame portion 56 downwardly within the mounting slot when the clamping member 52 is in a released position as shown in FIG. 5. When the clamping member 52 is rotated to a locking position a reaction element 64 on the frame 22 is engaged and cooperates with the member. That is, the element 64 is engaged by the clamping member 52 at an end opposite its handle 62 and urges the clamping device including frame 55 and depending portion 56, upwardly and leftwardly to securely engage the ends of the locking bar 58 with the rack gear sections 60, 60. As will be observed, the reaction element 64 is inclined upwardly and rightwardly in FIG. 5, and as shown in FIGS. 2, 3 and 5, preferably takes on a partially frusto-conical configuration. Forceful engagement between the clamping member 52 and the reaction element 64 results in simultaneous action whereby the locking bar 58 is urged upwardly into locking engagement with the rack gear as stated. The frame 22 is also urged downwardly and rightwardly in FIG. 5 by vertical and horizontal components of force. Slight horizontal movement is accommodated between the vise sub-assembly frame 22 and the clamping device 52 by virtue of the loose or “floating” connection therebetween. That is, the clamping device has no positive connection with the base 22 beyond the engagement between the member 52 and the reaction element 64. Thus, it will be seen that a secure engagement between both the base 22 and the table 12 and the workpiece and jaw 24 is provided for and the workpiece is positively held as desired.

As will be apparent from the foregoing, a very simple operation is provided for with the improved swivel vise of the present invention, it is necessary merely to loosen the binder bolts 42, 42, arrange the vise sub-assemblies 18, 20 at desired angles, re-tighten the bolts and thereafter secure the vise assemblies in position by operating the clamping members 52, 52 as described. The assemblies will thus be simultaneously locked in position on the table and the assembly jaws will firmly engage the workpiece. Compound angle cutting as well as a wide variety of other cutting operations may then be readily accommodated.

In the claims:

1. A swivel vise for use on a machine tool table having a generally horizontally extending upwardly exposed surface with at least one rectilinear vise mounting slot opening upwardly through the table surface; said vise comprising a pair of substantially identical vise sub-assemblies of opposite hand each having a base including a miter gauge and each being adapted to rest on and move linearly and angularly on said table surface, a vise jaw fixed to each base and extending upwardly therefrom and defining a substantially vertical clamping surface, a pair of said clamping surfaces being provided in opposing relationship when said two vise sub-assemblies are mounted on the machine table in operative relationship, and each vise sub-assembly also having first and second manually operable locking devices for cooperation with said mounting slot respectively to fix its corresponding vise sub-assembly in selected angular and linear positions along the slot, said sub-assemblies each being movable angularly through approximately ninety degrees (90°) relative to the table and slot, and said miter gauges serving to facilitate the desired angular setting of the two sub-assemblies relative to the table and to each other.

2. A swivel vise as set forth in claim 1 wherein each of said manually operable locking devices comprises a first locking device for fixing its associated jaw in selected angular relationships with the mounting slot and table, and a second locking device for fixing the vise sub-assembly in selected positions along the mounting slot.

3. A swivel vise as set forth in claim 2 wherein each first locking device is operatively associated with its miter gauge to facilitate visual selection of desired angular positions of the vise sub-assembly.

4. A swivel vise as set forth in claim 3 wherein said first locking device includes front and rear depending guides each of which enters and is restrained laterally by but is slidable along the mounting slot, the front guide being rotatable relative to the vise sub-assembly and the rear guide being mounted on the miter gauge for movement relative to the gauge along an arcuate path through approximately 90° and also adapted to be fixed relative to the gauge to establish selected angular positions of the vise assembly.

5. A swivel vise as set forth in claim 4 wherein each miter gauge takes the form of an arcuate member attached at its ends to the vise frame and forming a part thereof, each gauge also defining an arcuate slot slidably receiving an upper portion of its associated rear guide, and each rear guide having an associated binder bolt and an associated small clamping portion beneath the member for securing the guide in selected positions along its slot.

6. A swivel vise as set forth in claim 5 wherein each arcuate member is provided with graduated degree markings therealong adjacent its arcuate slot.

7. A swivel vise as set forth in claim 6 wherein each arcuate slot is particircular and extends through approximately forty five degrees (45°) in each direction away from a zero degree (0°) central mark.

8. A swivel vise as set forth in claim 1 wherein each of said second manually operable locking devices takes the form of a small frame holding a threaded clamping member adapted for manual manipulation and a depending portion adapted to enter said mounting slot and cooperate therewith in locking the vise sub-assembly at selected positions along the slot, and wherein a reaction element is provided for cooperation with said threaded clamping member in locking said depending member in selected positions along the mounting slot.

9. A swivel vise as set forth in claim 8 wherein said reaction element takes a generally frusto-conical configuration and said threaded clamping member is mounted angularly to engage a conical surface of the reaction element perpendicularly, the frame and depending portion of the locking device being thus drawn vertically upwardly by interaction of the threaded clamping member with the reaction element to simultaneously lock the depending portion in the mounting slot and to urge the associated jaw horizontally into firm engagement with an adjacent work piece.

10. A swivel vise as set forth in claim 9 wherein the mounting slot is of the Tee type and includes spaced inverted rack gear sections facing downwardly on each side of its neck, and wherein said depending portion of the manually operable device includes a small horizontal locking bar with opposite ends cooperating with said rack sections in securing the vise sub-assembly in selected positions along the slot.

11. A swivel vise as set forth in claim 10 wherein said threaded clamping member is rotatable and includes a small manually operable handle at an end opposite the reaction element.

12. A swivel vise as set forth in claim 1 wherein each of said jaws is mounted on its associated base for horizontal adjustment relative thereto.
